(19) United States
(12) Patent Application Publication
(10) Pub. No.: US 2007/0115978 A1
(43) Pub. Date: May 24, 2007

(54) Communication apparatus, method of controlling communication apparatus and control program for communication apparatus

(75) Inventor: Yuichi Kondo, Kanagawa-ken (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Ohta-ku, Tokyo (JP)

(21) Appl. No.: 10/576,526

(22) PCT Filed: Aug. 24, 2005
(86) PCT No.: PCT/JP05/15832

§ 371 Date: Apr. 20, 2006

(30) Foreign Application Priority Data
Aug. 25, 2004 (JP) 2004-244603

(51) Int. Cl. H04L 12/56

(52) U.S. Cl. 370/392; 370/401

(57) ABSTRACT

The invention realizes, utilizing a call control process according to SIP, detection of the condition of in terms of capableness/incapableness of receiving of the destination station and notification of restoration to a condition capable of receiving thereby eliminating troublesome operations such as telephonic communication etc.

### TECHNICAL FIELD

The present invention relates to a communication apparatus for transmitting and receiving data of a predetermined format through a network, a control method thereof and a control program therefor.

### BACKGROUND ART

Heretofore, in connection with communication apparatuses, particularly with communication apparatuses for transmitting and receiving data such as image data, there have been proposed various controls to be performed when communication fails due to some error such as when the destination station is busy.

For example, in the case of an early facsimile apparatus that can send and receive a call only by a manual operation, if it sends a call to a destination facsimile apparatus which is in a condition incapable of receiving the communication, for example when it is busy, and transmission of data is unsuccessful, it is necessary for the sending station to send a call again after a certain waiting time or after having communication with a user of the destination station by telephone etc. to confirm that the destination facsimile apparatus has been restored to a condition capable of receiving. However, in later facsimile-apparatuses having a memory function etc., a redial function for automatically trying transmission a predetermined number of times has been provided.

In the arrangement like the above-mentioned redial function by which transmission is automatically repeated if transmission fails, the destination facsimile apparatus responds to the transmission every time the transmission is tried even though the destination facsimile apparatus is in a condition incapable of receiving the transmission, and communication charge is incurred accordingly. In addition, it is required to repeat the same operation several times when the predetermined number of times of trial is over.

If several times of transmission trial fails for the reason that there is a trouble, such as a memory-full error, a paper jam or a lack of paper, that requires user's operation for restoration, it is necessary to communicate with the destination station by telephone etc. to inquire and to request restoration. In such cases, the sending station (which will also be referred to as the sending side hereinafter), for example, is required to perform telephonic communication for inquiry or requesting restoration etc., and the destination station (which will also be referred to as the incoming side or the receiving side) is required to perform not only restoring operations but also telephonic communication for informing the sender of the restoration. This is troublesome for both the sending station and the destination station.

Although the facsimile apparatus having a redial function automatically repeats transmission trial a predetermined number of times, if the destination apparatus has not been restored in the meantime to a condition capable of receiving, the transmission is terminated as a transmission error. Thereafter, it is necessary to repeat the transmission operation many times as is the case with the manual transmission. In addition, the problem that the destination station responds to every transmission with communication charge incurred also arises in this case.

In view of the above, in some systems, as will be seen from Japanese Patent Application Laid-Open No. Hll-32129, in the case where the destination station (the incoming side) is in a condition incapable of receiving, the destination station notifies the sending station of the fact that the destination station is incapable of receiving and stores the number of the sending station, and when the destination station is restored to a condition capable of receiving, it sends a call to the number of the sending station to notify the sending station of the fact that it has been restored. Upon receiving the notification of capableness of receiving, the sending station resends the data that-has not been able to be sent. Thus, useless re-transmissions and unnecessary telephonic communication can be eliminated.

However, according to the above-described prior art, the fact that the communication apparatus of the destination station is in a condition incapable of receiving cannot be known unless a call is actually sent to the destination station. Therefore, the destination station responds to the call with a charge incurred even if the destination station is incapable of receiving for some reason such as a memory full error. In addition, there is the problem that the notification of restoration from the condition incapable of receiving cannot be sent to the sending station when the destination station (the incoming/receiving side) cannot identify the telephone number of the sending station.

On the other hand, recently a communication protocol called SIP (Session Initiation Protocol: RFC2543) has been known as a bidirectional communication protocol with which user terminals can initiate a session equally on a network such as the Internet. This protocol is attracting attention as a communication protocol used in performing bidirectional communication using images and voice on, for example, the Internet. The SIP is used in the service called IP telephone (VoIP) or internet telephone.

In the SIP, an address called an SIP address similar to an E-mail address for uniquely identifying the user is uniquely assigned to each user (or the user's communication device). Correspondence between the SIP address assigned to each user and the real address (e.g. IP address) that identifies on the network the terminal used by that user is managed by a certain server apparatus (SIP location server).

For example, when a user logs in through a certain terminal to a network in order to perform a bidirectional session with SIP, the address of the terminal used by the user and the user's SIP address are associated with each other and registered in the SIP location server. When the address is changed, the address is notified to the SIP location server, and the address registered in the SIP location server is updated.

As per the above, the SIP location server always manages user's SIP addresses and terminals' addresses in association with each other. Therefore, if an SIP address is known, it is possible to identify the terminal of the user having that SIP address by referring to the SIP location server. In other words, it is possible to initiate a bidirectional session by designating the-SIP address of a user, through whichever terminal the user is connected to the network.

Therefore, it is considered that by using the above-described SIP, it is possible to perform detection of the condition of the destination station in terms of capability/incapability of receiving and notification of restoration to a condition capable of receiving very easily at a low cost.

### DISCLOSURE OF THE INVENTION

In view of the above-described circumstances, the present invention has as an object to realize detection of the condition of the destination station in terms of capableness/incapableness of receiving and notification of restoration to a condition capable of receiving, by utilizing call control message exchange based on SIP (Session Initiation Protocol) for setting and releasing a call between a sending station and a destination station, thereby enabling to eliminate useless resending from the sending station to the destination station and troublesome operations such as telephonic communication between the sending station and the destination station irrespective of the reason why the destination station is in a condition incapable of receiving.

According to the present invention, in a communication apparatus that transmits and receives data of a predetermined format through a network, a control method thereof and a control program thereof, communication apparatuses performing communication notify, upon sending a call, each other of a condition in terms of capableness/incapableness of communication by using SIP protocol. When a called side communication apparatus is in a condition incapable of communication, it sends a message indicating incapableness of communication as an SIP message to a calling side communication apparatus. The calling side communication apparatus that has received the message indicating incapableness of communication sends a notification of resuming-to-receive request message for requesting notification of resuming to receive as an SIP message if necessary When the called side communication apparatus that has received the notification of resuming-to-receive request message is restored to a condition capable of receiving, it sends a message notifying resuming to receive as an SIP message to the calling side communication apparatus that has sent the notification of resuming-to-receive request message. Thus, transmission and reception of communication data are performed in response to sending and receiving of the message notifying resuming to receive.

With the above features, it is possible to perform detection of the condition in terms of capableness/incapableness of receiving of the destination station and notification of restoration to a condition capable of receiving, by using the SIP protocol, thereby eliminating futile resending from the sending station to the destination station and troublesome telephonic communication etc. between the sending station and the destination station irrespective of the reason why the destination side is in a condition incapable of receiving.

### BRIEF DESCRIPTION OF THE DRAWINGS

FIG. 1 is a block diagram showing an example of the configuration of the facsimile apparatus to which the present invention is applied.

FIG. 2 illustrates an example of connection mode between facsimile apparatuses.

FIG. 3 is a flow chart of a receiving process in a receiving side facsimile apparatus to which the present invention is applied.

FIG. 4 is a flow chart of a transmission process in a sending side facsimile apparatus to which the present invention is applied.

FIG. 5 is a flow chart of a process for resuming to receive in the receiving side facsimile apparatus to which the present invention is applied.

FIG. 6 is a process following notification of resuming to receive in the sending side facsimile apparatus to which the present invention is applied.

FIG. 7 is a chart illustrating a call control process using SIP according to the present invention.

FIG. 8 is a memory map of a storage medium.

### BEST MODE FOR CARRYING OUT THE INVENTION

In the following, the best mode for carrying out the present invention will be described in detail with reference to a specific embodiment.

Although a facsimile apparatus will be described in the following description of the embodiments as an example of a communication apparatus, the present invention may be implemented in any communication apparatus so long as it is a communication apparatus that transmits and receives data of a predetermined format.

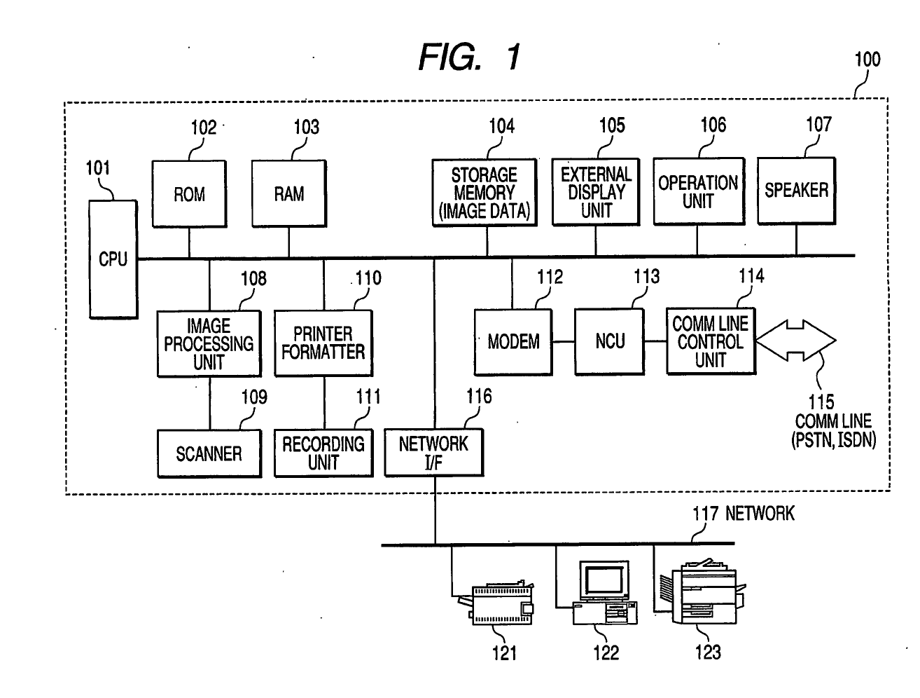

FIG. 1 shows the configuration of a facsimile apparatus 100 to which the present invention is applied.

In FIG. 1, reference numeral 101 designates a CPU constituting a system. control portion that controls the overall apparatus. Reference numeral 102 designates a ROM, in which a control program of the CPU is stored. Reference numeral 103 designates a RAM composed of a SRΔM or the like, which is used for storing program control variables etc. The RAM 103 is also adapted to store the line selecting method and various setting values set by an operator, control data of the apparatus and buffers for various works.

Reference numeral 104 designates a storage memory composed of a DRAM or the like, which stores image data to be sent or received.

Reference numeral 105 designates a display unit such as an LCD or LED used for displaying information to the user. Reference numeral 106 designates an operation unit composed of a keyboard, a touch panel or the like, which is used by the operator to effect various entry operations.

Reference numeral 107 designates a speaker, which is used to inform the user of the operation state and warning by sound or for monitoring an audible signal sent or received through a communication line (115) that will be described later.

Reference numeral 108 designates an image processing unit, which applies correction processing on read image data to output fine image data. Reference numeral 109 designates a scanner composed of an image sensor and an original conveying mechanism etc. The scanner 109 reads an original optically and converts it into an electric image data.

Reference numeral 110 designates a printer formatter, which analyses, upon printing of file data supplied from a workstation etc., printer description language and converts it into image data. Reference numeral 111 designates a recording unit, which is an apparatus that records a received image or file data on a recording sheet. The recording unit 111 may use any recording system such as an electrophotography system or an ink jet system.

Reference numeral 112 designates a modem, which modulates and demodulates facsimile signals sent and received. Reference numeral 113 designates a NCU, which has a function of sending a selection signal (i.e. dial pulse or dial tone) to a communication line 115 through a communication line control unit 114 and, in addition, performs automatic answering upon detection of rings. In the case where a telephone equipment and the like is externally connected, the NCU 113 performs connection exchange of lines with such devices.

Reference numeral 115 designates a communication line, which is, in this embodiment, a general public network (such as PSTN or ISDN).

Reference numeral 116 designates a network I/F, which is used as an interface between such device such as a printer 121, a computer 122, a copying machine 123 or the like connected to a network 117 (LAN) and the facsimile apparatus 100.

The facsimile apparatus 100 of this embodiment is connected to the network 117 through the network I/F 116, and it can receive printing data from the computer 122 on the network 117 to cause the recording unit 111 to record it, or forward image data obtained by image communication from the facsimile apparatus 100 to the computer 122.

The network 117 is a network, for example a LAN (local area network), in which TCP (UDP)/IP communication is possible, the network being built on a base network such as CSMA/CD (Ethernet (trade mark)).

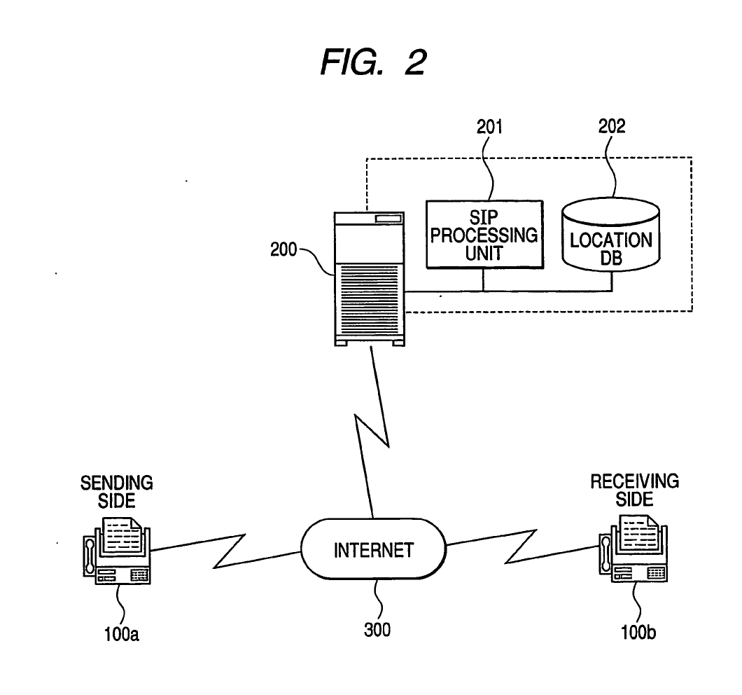

Next, the process relating to the present invention in the facsimile apparatus 100 having the above-described configuration will be described. In connection with this, the form of connection between facsimile apparatuses on which the process relating to the invention depends will be described with reference to a schematic diagram shown in FIG. 2.

In FIG. 2, a facsimile apparatus (FAX1) 100a of the sending side and a facsimile apparatus (FAX2) 100b of the receiving side, both of which have the same configuration as the facsimile apparatus 100 according to the present invention shown in FIG. 1, are connected to the Internet 300 (each of them being a VoIP terminal).

The connection to the Internet 300 may be done by dial-up via the communication line 115 shown in FIG. 1, or alternatively, achieved through the network 117 shown in FIG. 1, if the network 117 is routed to the Internet 300. In short, what is necessary is that the facsimile apparatuses 100a and 100b can use an SIP server 200 on the Internet 300 in sending and receiving a call.

The Internet 300 in FIG. 2 may be replaced by the network 117 in FIG. 1 (for example, in the case where the network 117 is a WAN such as an intranet). In this case, it is assumed that the SIP server 200 is disposed on the network 117.

Needless to say,—the facsimile apparatuses 100a and 100b are apparatuses that are assigned with specific addresses on a network such as the Internet 300 or the network 117 and send/receive data in the form of letters, voice and images to/from each other through the network. In such a process, the SIP is used in sending and receiving calls. In actual data communication, it is possible to use internet facsimile protocol (ITU-T Recommendation T.37/T.38), protocols for VoIP, transmission and reception protocol such as ftp and SMTP, or other original protocols. (It should be noted that in implementing the present invention, it is not necessarily required to use facsimile data format and facsimile related protocols.)

The SIP server 200 is constructed as a server apparatus that is connected to the Internet 300, controls SIP messages, and manages correspondence of specific addresses identifying the facsimile apparatuses 100a and 100b and SIP addresses identifying users.

The SIP server 200 has an SIP processing unit 201 and a location database unit 202. The SIP processing unit 201 performs processing for controlling messages sent and received in SIP. In response to a request from the facsimile apparatus 100a, the SIP server 200 associates the specific address of the facsimile apparatus 100b and the SIP address of the user of the facsimile apparatus. 100b with each other and register them in the location database unit 202.

Furthermore, in response to a request from the facsimile apparatus 100a, the SIP server 200 searches the location database unit 202 for the specific address associated with the designated SIP address. Then, on behalf of the facsimile apparatus 100a of the sending station, the SIP server 200 requests indirectly the facsimile apparatus 100b that has the specific address retrieved to initiate a session. Alternatively, the SIP server 200 may supply the facsimile apparatus 100a of the sending station with the specific address retrieved so that the facsimile apparatus 100a can directly request the facsimile apparatus 100b of the destination station for initiation of a session. The location database unit 202 is a database that manages the correspondence between specific addresses for identifying facsimile apparatuses 100 and SIP addresses for identifying users. The location database unit 202 performs registration and search upon request from the SIP processing unit 201.

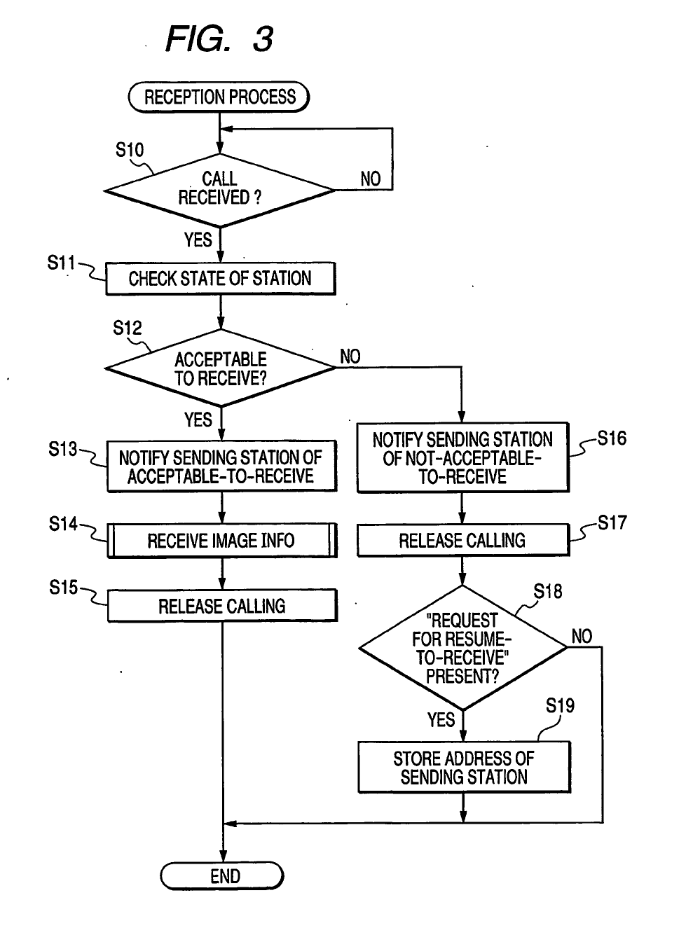

Next, a communication control process in sending a call from the sending side facsimile apparatus 100a to the destination side facsimile apparatus 100b with an intension to transmit image information data will be described. This communication control process has flows indicated by flow charts shown in FIGS. 3 to 6. The control processes shown in FIGS. 3 to 6 are implemented as control programs executed by the CPU 101 and stored, for example, in the ROM 103 shown in FIG. 1.

FIG. 3 is a flow chart of a reception process in the receiving side facsimile apparatus 100b.

Firstly in step SlO, the receiving side-facsimile apparatus 100b monitors incoming of a call setup message (INVITE, which will be described later) sent from the SIP server 200 through the Internet 300 and makes a determination as to whether a call is received or not. If a call is received, the process proceeds to step SIl.

In step SIl, the state of the apparatus is detected, for example various registers etc. indicative of the operation state of various portions of the apparatus are read, and the process proceeds to step S12

In step S12, a determination is made, based on the state of the apparatus obtained in step SlI, as to whether the apparatus is in a condition capable of receiving. Specifically, a determination is made as to whether or not there is a failure in the receiving function such as an apparatus error other than lack of paper or recording paper jam in the recording unit 11 or a memory-full error in the storage memory 105.

If it is determined here that there is not a failure in the receiving function and receiving is possible, the process proceeds to step S13. If there is a failure, the process proceeds to step S16.

In step S13, notification of acceptableness to receive is made to the sending station, and the process proceeds to step S14. In step S14, image information is received using a predetermined communication protocol. Thereafter, the process proceeds to step S15, where the call is released, and the reception process is terminated.

On the other hand, if it is determined in step S12 that the apparatus is incapable of receiving, in step S16 notification of non-acceptableness to receive is made to the sending station using an SIP message as will be described in detail later. Then, process proceeds to step S17, where the call is released, and thereafter the process proceeds to step S18.

In step S18, a determination is made as to whether a request for notification of resuming to receive (which request uses an SIP message as will be described later) from the sending station is present or not. If the request for notification of resuming to receive is present, the process proceeds to step S19, where the address of the sending station is stored, and thereafter the reception process is terminated. On the other hand, if the request for notification of resuming to receive is not present, the reception process is terminated.

Next, a transmission process in the sending side facsimile apparatus 100a corresponding to the reception process in the facsimile apparatus 100b shown in FIG. 3 will be described.

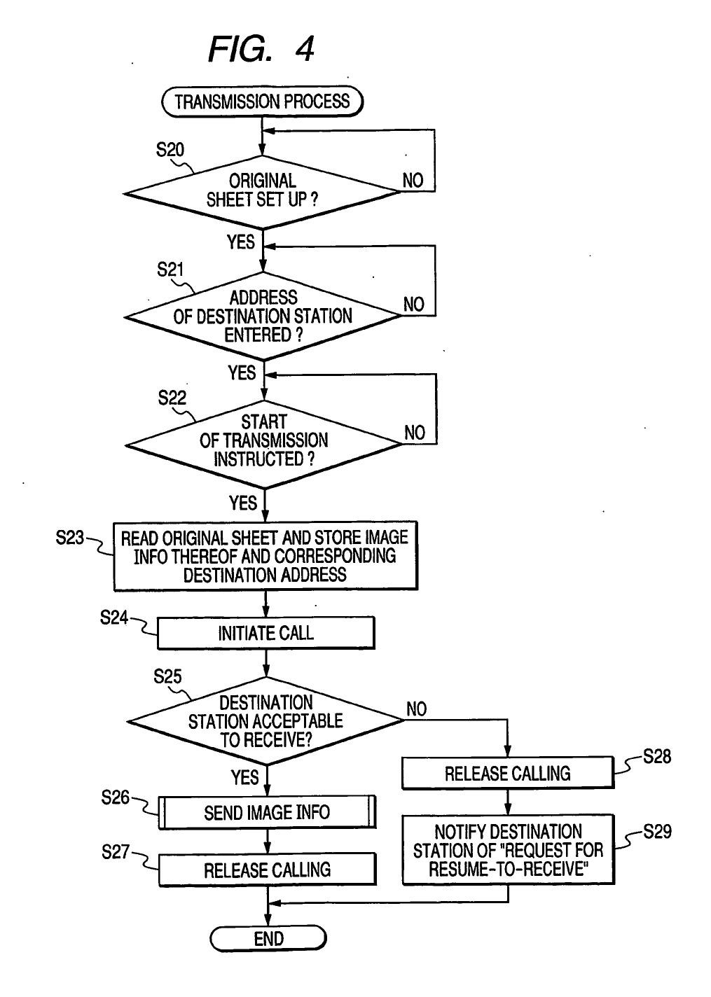

FIG. 4 shows the sequence of the transmission process in the sending side facsimile apparatus 100a.

Firstly in step S20, the sending side facsimile apparatus 100a monitors setting of an original sheet to be sent on the scanner 109. When an original sheet to be sent is set, the process proceeds to step S21.

In step S21, it is monitored whether or not the number of the destination station is entered by a user's operation through the operation unit 106. When the number of the destination station is entered, the process proceeds to step S22. In step S22, it is monitored whether or not a transmission start instruction is entered by depression of a start key provided in the operation unit 106. When the transmission start instruction is entered, the process proceeds to step S23, where the original sheet to be sent is read by the scanner 109 and image information thereof is stored in the storage memory 104 while associated with the destination address. After that, the process proceeds to step S24.

In step S24, a call is initiated to the destination address entered in step S21. Subsequently in step S25, a notification of reception condition from the destination station (or the receiving side) through an SIP message referred to in step S13 or S16 is received and a determination is made as to whether the destination station is capable of receiving. If the destination station is capable of receiving, the process proceeds to step S26, and if the destination station is incapable of receiving, the process proceeds to step S28.

If the destination station is capable of receiving, the image information stored in the aforementioned step S23 is transmitted in step S26. Then, the process proceeds to step S27, where the call is released and the transmission process is terminated. If the destination station is incapable of receiving, the call is released in step S28, and the process proceeds to step S29. In step S29, a request for notification of resuming to receive is sent to the destination station through an SIP message so that the-subject image data can be transmitted later when the destination station (the receiving side) has been restored to a condition capable of receiving. Then, the transmission process is terminated.

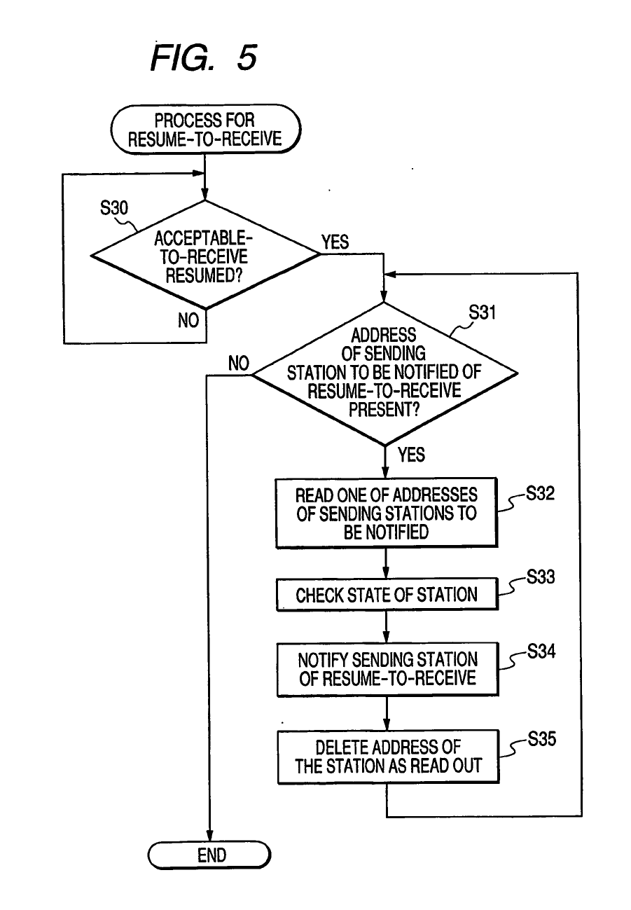

FIG. 5 shows a process for resuming to receive in the receiving side facsimile apparatus 100b for making notification of restoration from a condition incapable of receiving.

Firstly in step S30 in FIG. 5, it is monitored whether or not the receiving side facsimile apparatus 100b has been restored from the condition incapable of receiving, namely whether or not a failure in the receiving function such as an apparatus error other than lack of paper and recording paper jam or memory-full error in the storage memory 105 has been removed. If the receiving side facsimile apparatus 100b has been restored from the condition incapable of receiving, the process proceeds to step S31.

In step S31, the address of the sending station stored in the aforementioned step S19 is read, and a determination is made as to whether or not the address of the sending station to be notified of resuming to receive based on the request (the aforementioned step S29) from the sending station is stored in a predetermined area in the RAM 103.

If the address of a sending station (s) to be notified of resuming to receive is stored, the process proceeds to step S32, and if the address of a sending station (s) to be notified of resuming to receive is not stored, the process is terminated. In step S32, one of the addresses of the sending stations to be notified of resuming to receive is read. Then, process proceeds to step S33, where the condition of the apparatus is checked. After that, in step S34, a notification of resuming to receive is made to the sending station through an SIP message. In step S35, the address of the sending station read out in step S32 is deleted, and the process returns to step S31 to repeat the sequence until the address of the sending station to be notified of resuming to receive is exhausted.

Since the restoration has already been checked in step S30, the checking of the condition of the apparatus in step S33 is not necessarily essential and may be eliminated if circumstances, such as the processing speed of the CPU, demand. However, in the case where the step 33 is executed and it turns out that communication is impossible, the process for resuming to receive shown in FIG. 5 is stopped as a matter of course.

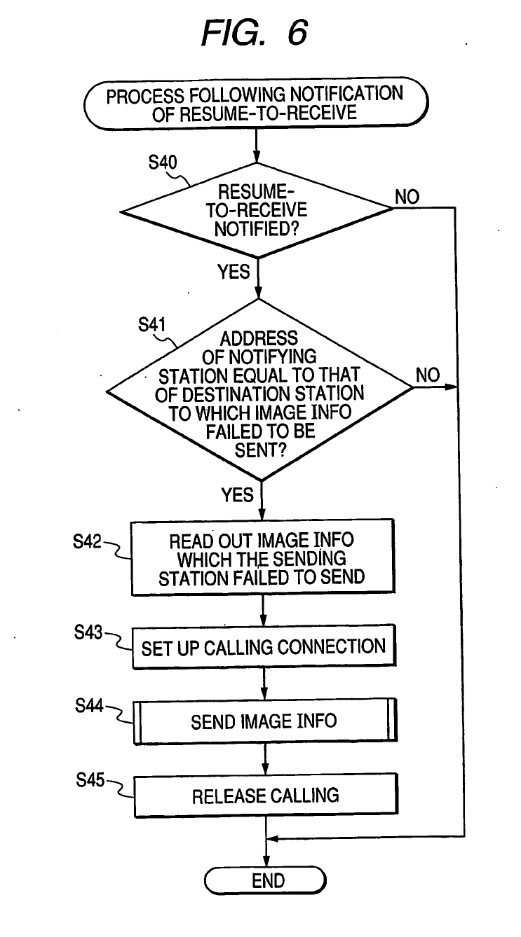

FIG. 6 shows a process following notification of resuming to receive executed by the sending side facsimile apparatus 100a upon receiving a notification of resuming to receive that indicates restoration from a condition incapable of receiving from the receiving side facsimile apparatus 100b.

Firstly in step S40, a determination is made as to whether or not the notification of resuming to receiving sent from the facsimile apparatus of the destination station (receiving side) by the aforementioned step S33 has been received. If the notification of resuming to receive has been received, the process proceeds to step S41, and if the notification of resuming to receive has not been received, the process is terminated.

If the notification of resuming to receive has been received, a determination is made in step s41 as to whether or not the address of the notifying station is identical with the address of the destination station, stored in the predetermined area in the RAM 103, in the aforementioned step S23, associated with the image information obtained by reading an original to be sent that failed to be sent.

If the corresponding address of the destination station is not stored in the predetermined area of the RAM 103, the process is terminated. If the identical address of the destination station is present, the image information that failed to be sent is read out in step S42. Subsequently in step S43, calling connection is set up to the address of the destination station associated with the image information. Then in step S44, the subject image information is sent. In step S45, the call is released, and then the process is terminated.

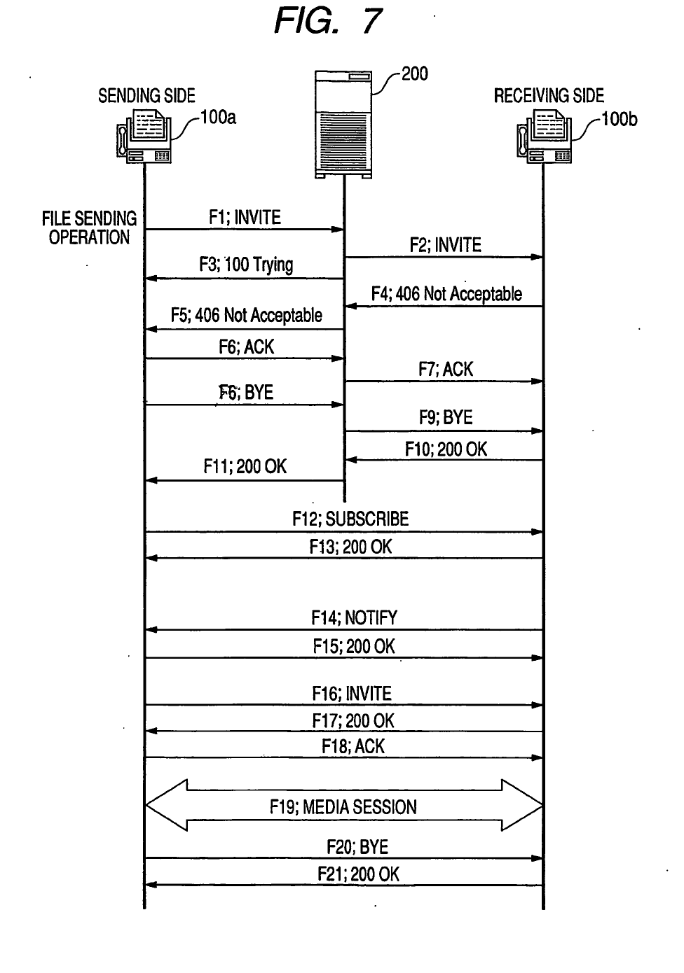

Next, a call control sequence according to this embodiment will be described with reference to FIG. 7. The communication control processes shown in FIGS. 3 to 6 are executed in accordance with the communication sequence using SIP shown in FIG. 7. The following description of each step of the sequence shown in FIG. 7 will be made with reference to sequence numbers (Fl, F2 . . . F21) indicated in FIG. 7.

Firstly, in the sending side facsimile apparatus 100a, the user sets an original to be sent on the scanner 109, and enters the address of the destination station through the operation unit 106. In response to depression of the start key on the operation unit 106 after entry of the address of the destination station, the original to be sent is read, and the image data thereof is stored in the storage memory 104 while associated with the address of the destination station.

The sending side facsimile apparatus 100a sends (F1) to the SIP server 200 a message requesting call connection (participation into a session; INVITE) for the address of the destination station entered. The SIP server 200 receives this message Fl, and searches the location database 202 for the specific address corresponding to the designated SIP address. The system may be arranged in such a way that the whole or a part of the location database is managed by a different server and the SIP server 200 is adapted to request this server to conduct the search according to need.

Then, the SIP server 200 sends (F2) a message requesting call connection (participation into a session; INVITE) to the facsimile apparatus 100b having the address retrieved and sends (F3) a response message (100 Trying) to the sending side.

The facsimile apparatus 100b of the receiving side (destination station) checks reception of the message F2 and the receiving condition and sends (F4) a response message indicating the receiving condition to the SIP server 200. In the case shown in FIG. 7, the receiving side facsimile apparatus 100b is in a condition incapable of receiving and sends a response message (406 Not Acceptable) indicating the condition incapable of receiving.

The SIP message “406 Not Acceptable” indicating the condition incapable of receiving is a standard message described in RFC2543 that defines SIP standards.

The SIP server 200 receives this message F4 and forwards (F5) it to the sending side. Upon receiving the message F5, the sending side apparatus sends (F6) a final response (ACK) to the call connection (participation in a session; INVITE) to the SIP server 200. The SIP server 200 receives the message F6 and forwards (F7) it to the receiving side.

In the case where the sending side receives, as the message F5, a message indicating capableness of receiving (Acceptable), the process enters the media session (F19) shown in the lower part of FIG. 7, where transmission and reception of the image data are conducted directly between the sending side and the receiving side. After completion of the transmission and reception of the image data, the sending side sends (F20) a message requesting call release (termination of the session; BYE) to the receiving side. The receiving side receives the message F20 and sends (F21) a response message (200 OK) to the sending side.

On the other hand, in the case where the sending side receives, as the message F5, a message indicating incapableness of receiving (Not Acceptable) as shown in FIG. 7, the sending side sends (F8) a message requesting call release (termination of the session; BYE) to the SIP server 200. The SIP server 200 receives the message F8 and forwards (F9) it to the receiving side.

The receiving side receives the message F8 and sends (FlO) a response message (200 OK) to the SIP sever 200. The SIP server 200 receives the message FlO and forwards (FIl) it to the sending side.

In response to this, the sending side sends (F12) a message requesting notification of resuming to receive (SUBSCRIBE) so that the receiving side will send a notification of resuming to receive when it is restored to a condition capable of receiving. The receiving side receives the message F12 and sends (F13) a response message (200 OK) to the sending side.

In this way, the receiving side stores the address of the sending side and waits for restoration to a condition capable of receiving. Thus, when the receiving side is restored from the busy state or restored to a condition capable of receiving by removal of errors such as paper jam, the process enters the process for resuming to receive.

In the process for resuming to receive, the receiving side reads out the address of the sending side that has been stored and sends (F14) a message (NOTIFY) notifying of resuming to receive to the sending side. Upon receiving this message F14, the sending side sends (F15) a response message (200 OK) to the receiving side and sends (F16) a message requesting call connection (participation in a session; INVITE).

Among the SIP messages mentioned in the above, the message requesting notification of resuming to receive “SUBSCRIBE” and the message notifying of resuming to receive “NOTIFY” are defined in RFC32 65, and they can be used by communication apparatuses to mutually inquire/notify the other apparatus about/of information on provision of communication resources and conditions.

The message requesting notification of resuming to receive “SUBSCRIBE” and the message notifying of resuming to receive “NOTIFY” are SIP messages, and therefore it is possible, of course, to include addresses (such as SIP addresses, IP addresses or user's names) that can specify the own apparatus and the destination apparatus in them using headers such as “To:” and “From:” in compliance with RFC822. Thus, these addresses enable the address storage in step S19 in FIG. 3 and the address verification in S41 in FIG. 6.

The media session (transmission and reception of image information) performed after receiving message “NOTIFY” that notifies of resuming to receive (F14 in FIG. 7) can utilize the addresses (such as SIP addresses, IP addresses or user's names) that can specify the own apparatus and the destination apparatus included in the above-mentioned message. Therefore, the media session can be performed on a peer-to-peer basis without need for call setup by way of the SIP server.

The receiving side receives the messages F15 and F16 sequentially and sends (F17) a response message (200 OK) to the sending side. The sending side receives this message F17 and sends (F18) a final response (ACK) to the call connection (participation in a session; INVITE) to the receiving side. Then, the process enters a media session (F19) between the sending side and the receiving side, so that the image data is transmitted and received. After completion of the transmission and reception of the image data, the sending side sends (F20) a message requesting call release (termination of the session; BYE) to the receiving side. Upon receiving this message F20, the receiving side sends (F21) a response message (200 OK) to the sending side.

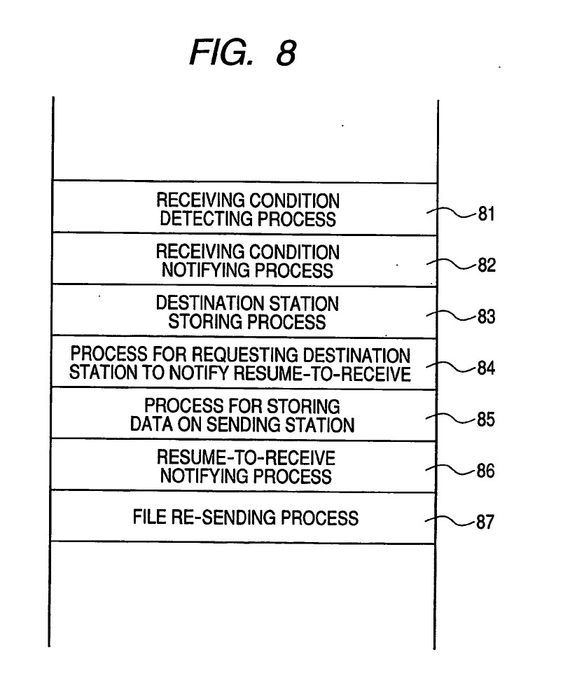

FIG. 8 shows an example of the location in a memory, of software modules of the software for carrying out the present invention stored in a memory medium such as the ROM 103. In FIG. 8, software modules for executing the above-described communication processes are stored in the memory in the following order: receiving condition detecting process 81, receiving condition notifying process 82, destination station storing process 83, process for requesting destination station to notify resume-to-receive 84, process for storing data on sending station 85, resume-to-receive notifying process 86 and file re-sending process 87.

Among the above processes, the receiving condition detecting process 81 is a process of detecting the above-mentioned paper jam, errors or busy state caused by other reasons. The receiving condition notifying process 82 is a process of sending a receiving condition notification message in accordance with the detection result of the receiving condition detecting process 81. The destination station storing process 83 is a process of storing the phone number, SIP address or IP address etc. of the destination station (receiving side). The process for requesting destination station to notify resume-to-receive 84 is a process of requesting the destination station (receiving side) to send a notification of acceptableness to receive (resuming to receive). The process for storing data on sending station 85 is a process of storing the phone number, SIP address or IP address of the sending station that has sent a request for notification of acceptableness to receive (resuming to receive) and control information necessary for the notification. The resume-to-receive notifying process 86 is a process of sending a message notifying acceptableness to receive (resuming to receive). The file re-sending process 87 is a process of resending data such as image information in response to reception of the message notifying acceptableness to receive (resuming to receive).

Needless to say, the name of each process and the order of the processes shown in FIG. 8 in the storage may be determined freely, and it is not necessary for the processes to be arranged in a manner as shown in FIG. 8.

In the foregoing descriptions, it has been assumed that the calling side is the data sending side and the called side is the data receiving side. However, it is apparent that the direction of transmission and reception of image data may be reversed. For example, the above-described control also applies without modifications to cases where the sending side and the, receiving side are changed to the calling side and the called side, or where the terms “acceptableness to receive”, “non-acceptableness to receive” and “resuming to receive” are changed to the terms “acceptableness to transmit”, “non-acceptableness to transmit” and “resuming to transmit.”

As per the above, according to this embodiment, communication apparatuses can notify, upon sending a call, each other of the capableness/incapableness of communication using SIP. If an apparatus is in a condition incapable of communicating, a message notifying incapableness of communication is sent, and the receiving side that has received the message notifying incapableness of communication can send, if necessary, a message requesting notification of resuming of communication to request notification of restoration to a condition capable of communicating. Thus, it is possible to realize successful subject communication reliably as a result of transmission and reception of the message notifying resuming of communication

Therefore, according to this embodiment, a plural number of times of fruitless resending process is eliminated unlike with conventional apparatuses, and it is possible to prevent futile repetition of resending from the sending side to the receiving side irrespective of the reason why the destination side is in a condition incapable of receiving.

The messages notifying capableness/incapableness of communication and the message requesting notification of resuming of communication can be sent and received using SIP on the Internet at a very low cost (or substantially for free). Thus, it is possible to reduce the communication cost. In addition, by using SIP, which is effective in establishing communication between devices such as registration and resolution of addresses and notification of events and conditions, it is possible to recognize the other station before conducting communication easily.

In IP communication, either of Ipv4 and Ipvβ may be used. However, by using Ipvβ particularly, it is possible to identify the sending and receiving terminals (e.g. IP telephone or VoIP terminals) by using global addresses assured without effecting NAT avoiding process and to communicate on a peer-to-peer (P2P) basis.

This application claims priority from Japanese Patent Application No. 2004-244603 filed on Aug. 25, 2004, which is hereby incorporated by reference herein.

1. A communication apparatus that transmits and receives data of-a predetermined format through a network comprising:
detection means with which a called side communication apparatus detects a condition capable or incapable of communication in accordance with its own condition;
means for sending, when a call has been issued and received and it is detected by said detection means that the called side communication apparatus is in a condition incapable of communication, a message indicating incapableness of communication as an SIP message from the called side communication apparatus to a calling side communication apparatus upon sending and receiving a call;
means with which the calling side communication apparatus that has received the message indicating incapableness of communication sends a notification of resuming-to-receive request message for requesting notification of resuming to receive as an SIP message, if necessary; and
means with which the called side communication apparatus that has received the .notification of resuming-to-receive request message sends, when a condition capable of communication is detected by said detection means, a message notifying resuming to receive as an SIP message to the calling side communication apparatus that has sent the notification of resuming-to-receive request message,
wherein transmission and reception of communication data are performed in response to sending and receiving of the message notifying resuming to receive.

2. A control method for communication apparatuses that transmit and receive data of a predetermined format through a network, wherein
in sending a call, communication apparatuses performing communication notify each other of a condition in terms of capableness/incapableness of communication using SIP protocol,
when a called side communication apparatus is in a condition incapable of communication, it sends a message indicating incapableness of communication as an SIP message to a calling side communication apparatus,
the calling side communication apparatus that has received the message indicating incapableness of communication sends a notification of resuming-to-receive request message for requesting notification of resuming to receive as an SIP message, if necessary,
when the called side communication apparatus that has received the notification of resuming-to-receive request message is restored to a condition capable of receiving, it sends a message notifying resuming to receive as an SIP message to the calling side communication apparatus that has sent the notification of resuming-to-receive request message, and
transmission and reception of communication data are performed in response to sending and receiving of the message notifying resuming to receive.

3. A control program of communication apparatuses that transmit and receive data of a predetermined format through a network, wherein
in sending a call, communication apparatuses performing communication notify each other of a condition in terms of capableness/incapableness of communication using SIP protocol,
when a called side communication apparatus is in a condition incapable of communication, it sends a message indicating incapableness of communication as an SIP message to a calling side communication apparatus,
the calling side communication apparatus that has received the message indicating incapableness of communication sends a notification of resuming-to-receive request message for requesting notification of resuming to receive as an SIP message, if necessary,
when the called side communication apparatus that has received the notification of resuming-to-receive request message is restored to a condition capable of receiving, it sends a message notifying resuming to receive as an SIP message to the calling side communication apparatus that has sent the notification of resuming-to-receive request message, and
transmission and reception of communication data are performed in response to sending and receiving of the message notifying resuming to receive.

4. A communication system that transmits and receives data of a predetermined format through a network comprising:
detection means with which a called side communication apparatus detects a condition capable or incapable of communication in accordance with its own condition;
means for sending, when a call has been issued and received and it is detected by said detection means that the called side communication apparatus is in a condition incapable of communication, a message indicating incapableness of communication as an SIP message from the called side communication apparatus to a calling side communication apparatus upon sending and receiving a call;
means with which the calling side communication apparatus that has received the message indicating incapableness of communication sends a notification of resuming-to-receive request message for requesting notification of resuming to receive as an SIP message, if necessary; and
means with which the called side communication apparatus that has received the notification of resuming-to-receive request message sends, when a condition capable of communication is detected by said detection means, a message notifying resuming to receive as an SIP message to the calling side communication apparatus that has sent the notification of resuming-to-receive request message,
wherein transmission and reception of communication data are performed in response to sending and receiving of the message notifying-resuming to receive.
